(19) United States
(12) Patent Application Publication
(10) Pub. No.: US 2020/0318727 A1
(43) Pub. Date: Oct. 8, 2020

(54) TRANSMISSION FOR A COMMERCIAL VEHICLE WITH A TRANSMISSION HOUSING WITH A VENTING ARRANGEMENT

(71) Applicant: ZF Friedrichshafen AG, Friedrichshafen (DE)

(72) Inventors: Georg EGE, Kressbronn am Bodensee (DE); Hermann LANZ, Frickingen (DE)

(21) Appl. No.: 16/839,427

(22) Filed: Apr. 3, 2020

(30) Foreign Application Priority Data
Apr. 5, 2019 (DE) 10 2019 204 907.9

(51) Int. Cl. F16H 57/027; F16H 57/04

(52) U.S. Cl. CPC F16H 57/027; F16H 2057/0206; F16H 57/0461

(57) ABSTRACT

A transmission for a commercial vehicle that has a transmission housing in which at least one venting arrangement, for equalizing the pressure between an inside space of the transmission housing and the surroundings of the transmission housing, is provided. The arrangement includes a vent fixed on a wall of the transmission housing on the surroundings side. The vent is connected by way of an oil foam reducing venting channel to at least one inside space of the transmission housing. At least a first venting bore, on the inside space side, and a second venting bore, on the vent side, are provided as the venting channel such that, in relation to their cross-sections, the venting bores are offset relative to one another, at their connection area, in such manner that a step-shaped transition is formed in the connection area between the venting bores.

This application claims priority from German patent application serial no. 10 2019 204 907.9 filed Apr. 5, 2020.

### FIELD OF THE INVENTION

The present invention relates to a transmission for a commercial vehicle, having a transmission housing with at least one venting arrangement for equalizing the pressure between an inside space of the transmission housing and the surroundings of the transmission housing.

### BACKGROUND OF THE INVENTION

Venting arrangements for venting or pressure equalization between an inside space of a transmission housing and the surroundings or the atmosphere are known in automotive technology. The venting arrangement serves to discharge air under different environmental and working conditions from the inside space of the transmission housing to be vented, without any addition of oil, water or the like. For that purpose venting arrangements with separating labyrinths of complex design are provided, which are connected to a vent. The separating labyrinth separates oil from the oil foam present in the inside space of the transmission housing and returns it to the oil sump. This prevents oil in the interior of the transmission housing from being discharged together with the air into the surroundings.

For example, from the document DE 10 2008 043 629 A1 a transmission device having a transmission housing with a venting arrangement is known. The venting arrangement comprises a hollow space delimited by an additional sealing element, which by way of a separating labyrinth acting as a venting channel connects the inside space of a first part of the transmission housing to the inside space of a second part of the transmission housing. Thus, a venting arrangement of elaborate design is produced between two inside spaces of a transmission housing.

### SUMMARY OF THE INVENTION

The purpose of the present invention is to propose a transmission of the type described at the start, with a venting arrangement, and also a commercial vehicle with the transmission, which ensure a particularly simply designed and inexpensive venting arrangement.

According to the invention, this objective is achieved by virtue of the characteristics specified in the independent claims, while advantageous and claimed further developments emerge from the subordinate claims, the description and the drawings.

Thus, a transmission of a commercial vehicle having a transmission housing is proposed, in which at least one venting arrangement for equalizing the pressure between an inside space of the transmission housing and the surroundings of the transmission housing or the atmosphere is provided, which arrangement comprises a vent attached on a wall of the transmission housing on the surroundings side, the vent being connected with an inside space of the transmission housing via at least one oil foam reducing venting channel. To produce a simply designed and inexpensive venting arrangement, it is provided that as the venting channel at least one venting bore on the inside space side and a second venting bore on the vent side are provided, such that the venting bores in their connection area that connects the two venting bores to one another are in relation to their cross-section arranged offset from one another in such manner that a step-shaped transition for reducing the oil foam in the connection area is provided between the venting bores.

In this way, a venting arrangement with vent holes that are particularly easy to manufacture is realized in the proposed transmission, the oil foam reduction being made possible in an advantageous manner by separating oil from the oil foam at the step-like transition of the connection area of the vent holes. Thereby, not only is a particularly simply produced and inexpensive venting arrangement provided in the transmission, but also one which functions optimally.

Since the first venting bore passes through an intermediate plate and the second venting bore passes through a flange area in the wall of the transmission housing, a further advantage relating to production is obtained in that the venting bores of the venting arrangement are integrated in transmission flange surfaces in a manner particularly simple to produce by machining. The production of the venting bores can thus advantageously take place during the machining of the intermediate plate and the transmission flange geometries.

In an advantageous further development of the invention it can be provided that the connection area between the venting bores is formed on the flange area of the wall of the transmission housing that faces toward the intermediate plate. In that way the connection area is formed, as it were, through the flange surfaces on the intermediate plate and on the wall of the transmission housing, and no additional production steps are needed.

So that the oil foam entering the venting arrangement or the venting bores will still be successfully dispersed and the oil separated, it is provided that the peripheral edges on the inside diameter of the capture area and/or the end area of at least one, preferably the first venting bore are made sharp-edged in order to reduce the oil foam. As result the bubbles of the oil foam are changed or broken up or burst at the sharp peripheral edges. It has been shown that a peripheral edge angle of around 90°, i.e. essentially a right-angle, is advantageous. It is possible, however, to adapt the angle in one or the other direction as appropriate.

A further clear improvement of the venting is achieved in the transmission proposed if the first venting bore opens into an intermediate space where the oil is not agitated. Consequently, oil does not impinge directly on the first venting bore on the inside space side. It is particularly advantageous if as the intermediate space a power take-off space is used, in which on the one hand the oil is not agitated and on the other hand a further function is served, namely that of accommodating the power take-off.

The oil foam reduction is further improved by geometrical changes between the two venting bores, since such geometrical changes also result in different creep speeds of the oil foam. This further improves the separation of the air and the fluid or oil. The geometrical changes can relate to both the dimensions and the shape of the venting bores.

To return the oil or fluid separated from the oil foam back to the sump, it is provided that the first venting bore preferably follows an inclined path to facilitate the return of the oil.

Another aspect of the present invention provides that by virtue of the present invention a commercial vehicle with the transmission described is claimed. The commercial vehicle can be for example a motor vehicle, a ground-level transport vehicle, a truck or the like. During the use of such a commercial vehicle the advantages already described, and other as well, are obtained.

### BRIEF DESCRIPTION OF THE DRAWINGS

Below, the present invention is explained further with reference to the drawings, which show:

FIG. 1: A schematic, sectioned view of a possible embodiment variant of a transmission according to the invention with a venting arrangement; and

FIG. 2: Schematically, a detailed sectioned view according to FIG. 1.

### DETAILED DESCRIPTION OF THE PREFERRED EMBODIMENTS

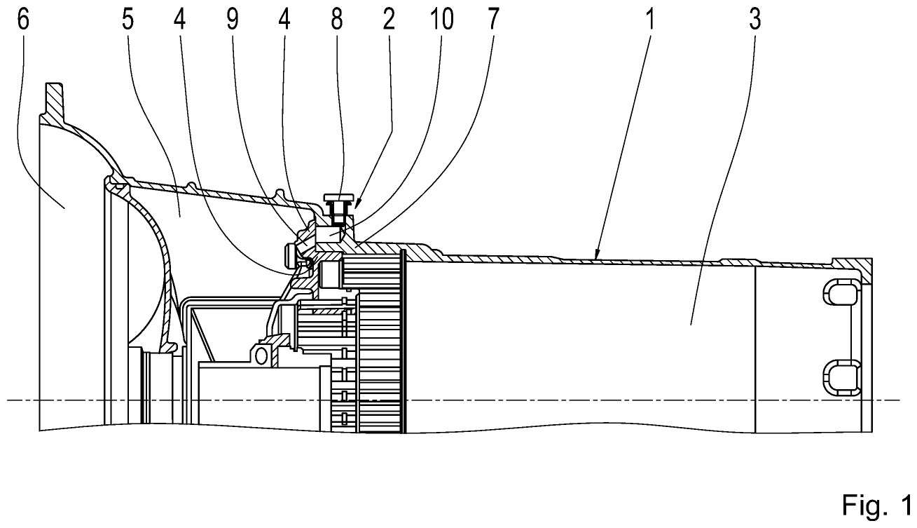

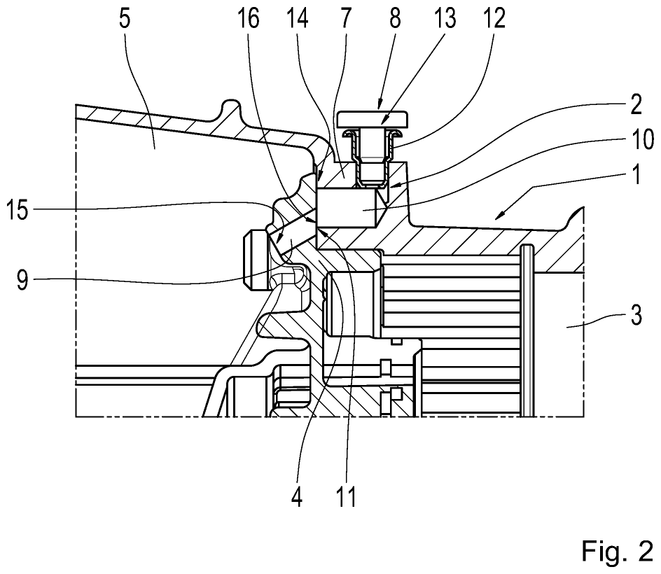

In FIGS. 1 and 2 a possible embodiment variant of a transmission of a vehicle, in particular a commercial vehicle is shown as an example, the transmission having a transmission housing 1 in which at least one venting arrangement 2 is provided for equalizing the pressure between an inside space of the transmission housing 1 and the surroundings of the transmission housing 1. The transmission shown as an example is a transmission for any type of commercial vehicle, such as a pickup or some other special vehicle which needs at least one power take-off in order to be able to tap off appropriate drive power for a hydraulic system or the like.

The transmission housing 1 shown as an example has essentially three functional spaces on its inside. First there is an oil-flushed gearing space 3 in which the transmission gearing with the shifting elements are accommodated. In addition, an intermediate space 5 separated from the gearing space 3 by an intermediate plate 4 is provided, which for venting purposes communicates with the gearing space 3 but in which the oil is not agitated. Connected to the intermediate space 5 is the so-termed converter space for the torque converter of the transmission.

The venting arrangement 2 of the transmission comprises a vent 8 attached on the wall of the transmission housing 1, which connects the surroundings of the transmission to the inside space of the transmission housing 1 by way of an oil foam reducing venting channel.

In order to produce a venting arrangement 2 as simply designed and as inexpensive as possible, it is provided that as the venting channel a first venting bore 9 on the inside space side and a second venting bore 10 on the vent side are provided, wherein the venting bores 9, 10 in their connection area 14, relative to their cross-section, are offset with respect to one another in such manner that a step-shaped transition 11 is provided at the connection area 14 between the venting bores 9, 10. At this step-shaped transition 11 the oil is separated from the incoming oil foam, so that the oil can flow back into the oil sump of the transmission housing 1.

As can be seen in particular in the detailed view shown in FIG. 2, the first venting bore 9 passes through the intermediate plate 4 and the second venting bore passes through a flange area in the wall 7 of the transmission housing 1. The connection area 14 of the two venting bores 9, 10 is on the flange area of the wall 7 of the transmission housing 1 that faces toward the intermediate plate 4. By virtue of the arrangement of the two venting bores 9, 10 offset in relation to their cross-sections, the step-shaped transition 11 is formed.

The oil foam reduction or separation of the oil from the oil foam is further improved in that on the peripheral edges extending around the inside diameter, or inner peripheral edge, both in the capture area 15, i.e. at the inlet opening, and also the end area 16, i.e. at the outlet opening of the first venting bore 9, the edges are made sharp. Since the end area 16 of the first venting bore 9 corresponds to the connection area 14 of the venting bores 9, 10, the step-shaped transition 11 is also sharp-edged. The edge angle of the respective peripheral edges can amount to around 90°. This breaks down the oil foam bubbles and the oil is separated out.

Owing to the different diameter geometries of the first venting bore 9, which for example has a smaller diameter, and the second venting bore 10, which for example has a larger diameter, the creep speed of the oil foam varies, whereby the oil separation is further improved so that the oil-free venting of the transmission is optimized.

Since the first venting bore 9 opens into the intermediate space 5 in which the oil is not agitated, which space is separated by the intermediate plate 4 from the gearing space 3 which is flushed with oil, the amount of oil foam that can make its way into the first venting bore 9 is reduced further.

In a particularly advantageous manner, the intermediate space 5 is designed as a power take-off space which is already present in a commercial vehicle in order to be able to accommodate the power take-off.

Furthermore, it can be seen from FIG. 2 that the first venting bore 9 is shaped suitably for the return of oil. For example the second venting bore 10 extends horizontally, so that the vertically arranged vent 8 can be positioned after the horizontally extending second venting bore 10. Thanks to this horizontal path it is ensured that only air can emerge through the vent 8 arranged vertically relative to it for pressure equalization purposes. In the embodiment variant illustrated, the vent 8 is made with a press-on casing 12 which is positioned in a bore that opens into the second venting bore 10. The press-on casing 12 holds a sieve insert 13.

### INDEXES

1 Transmission housing
2 Venting arrangement
3 Gearing space
4 Intermediate plate
5 Intermediate space
6 Converter space
7 Wall
8 Vent
9 First venting bore
10 Second venting bore
11 Step-shaped transition
12 Press-on casing
13 Sieve insert
14 Connection area
15 Capture area of the first venting bore
16 End area of the first venting bore

1-11. (canceled)

12. A transmission for a commercial vehicle comprising:
a transmission housing (1) in which at least one venting arrangement (2) is provided for pressure equalization between at least one inside space of the transmission housing (1) and a surrounding of the transmission housing (1),
the venting arrangement having a vent (8) fixed on a wall (7) of the transmission housing (1) on a surroundings side,
the vent being connected by at least one oil foam reducing venting channel to the at least one inside space of the transmission housing (1), and
at least one first venting bore (9), on an inside space side, and a second venting bore (10), on a vent side, are provided as the venting channel such that at a connection area (14) thereof, in relation to their cross-sections, the first and the second venting bores (9, 10) are offset relative to one another in such manner that a step-shaped transition (11) is formed at the connection area (14) between the first and the second venting bores (9, 10).

13. The transmission according to claim 12, wherein the first venting bore (9) passes through an intermediate plate (4) and the second venting bore (10) passes through a flange area in the wall (7) of the transmission housing (1).

14. The transmission according to claim 13, wherein the connection area (14) of the first and the second venting bores (9, 10) is located on the flange area of the wall (7) of the transmission housing (1) that faces toward the intermediate plate (4).

15. The transmission according to claim 12, wherein at least one peripheral edge around at least one of an inside diameter of a capture area (15) and an end area (16) of the first venting bore (9) has a sharp-edge in order to reduce the oil foam.

16. The transmission according to claim 15, wherein an edge angle of the at least one peripheral edge is around 90°.

17. The transmission according to claim 12, wherein the first and the second venting bores (9, 10) have different diameter geometries.

18. The transmission according to claim 13, wherein the first venting bore (9) opens into an intermediate space (5) in which oil is not agitated, the intermediate space is spatially separated by an intermediate plate (4) from a gearing space (3) which is flushed with oil and which, for venting purposes, communicates with the gearing space (3).

19. The transmission according to claim 18, wherein the intermediate space (5) is designed as a power take-off space.

20. The transmission according to claim 12, wherein at least the first venting bore (9) follows a suitable path for oil return purposes.

21. The transmission according to claim 12, wherein the second venting bore (10) extends approximately horizontally and a vertically orientated connection for the vent (8) is arranged after the second venting bore (10).

22. A commercial vehicle with a transmission comprising a transmission housing (1) in which at least one venting arrangement (2) is provided for pressure equalization between at least one inside space of the transmission housing (1) and a surrounding of the transmission housing (1), the venting arrangement having a vent (8) fixed on a wall (7) of the transmission housing (1), on a surrounding side, the vent is connected by at least one oil foam reducing venting channel to the at least one inside space of the transmission housing (1), and at least one first venting bore (9), on an inside space side, and a second venting bore (10), on a vent side, are provided as the venting channel such that at a connection area (14) thereof, in relation to their cross-sections, the first and the second venting bores (9, 10) are offset relative to one another in such manner that a step-shaped transition (11) is formed at the connection area (14) between the first and the second venting bores (9, 10).

23. A transmission for a commercial vehicle, the transmission comprising:
a transmission housing (1) having at least one venting arrangement (2) for equalizing pressure between an interior of the transmission housing (1) and an exterior of the transmission housing (1);
the venting arrangement (2) having a vent (8) fixed on an exterior side of a wall (7) of the transmission housing (1), the vent being connected, via at least one oil foam reducing venting channel, to at least one interior space of the transmission housing (1);
the venting channel comprises a first venting passage (9), located on an interior side of the venting channel, and a second venting passage (10), located on a vent side of the venting channel, the first and the second venting passages being connect to each other at a connection area (14), and a cross-section of the first venting channel and a cross-section of the second venting channel are offset relative to each other such that a step-shaped transition (11) being formed at the connection area (14) between the first and the second venting channels (9, 10).
